(19) United States
(12) Patent Application Publication
(10) Pub. No.: US 2026/0265107 A1
(43) Pub. Date: Sep. 10, 2026

(54) METHOD FOR HIGHLY EFFICIENT IN-SITU ENRICHMENT OF ANAEROBIC AMMONIUM OXIDIZING BACTERIA

(71) Applicant: TONGJI UNIVERSITY, Shanghai (CN)

(72) Inventors: Yayi WANG, Shanghai (CN); Hao SHENG, Shanghai (CN); Han WANG, Shanghai (CN)

(73) Assignee: TONGJI UNIVERSITY, Shanghai (CN)

(21) Appl. No.: 18/841,387

(22) PCT Filed: Oct. 31, 2023
(86) PCT No.: PCT/CN2023/128098

§ 371 Date: Aug. 25, 2024

(51) Int. Cl. C02F 11/04

(52) U.S. Cl. CPC C02F 11/04

(57) ABSTRACT

The present invention relates to a method for highly efficient in-situ enrichment of anaerobic ammonium oxidizing bacteria (AnAOB), which comprises: using anaerobic digestion sludge as inoculum sludge, nitrate wastewater as influent in the experimental group, ammonium and nitrite wastewater as influent in the control group. The inoculum sludge and influent are reacted under conditions of light avoidance, constant temperature, and anaerobic environment to enrich AnAOB. Compared with existing technology, the present invention uses anaerobic digestion sludge as inoculum sludge and nitrate wastewater as influent to enrich AnAOB. After about 30 days of operation, the absolute abundance of AnAOB functional genes HzsB increased by about 100 times compared to the control group (6.90E+04 copies/ng DNA→6.73E+06 copies/ng DNA).

### TECHNICAL FIELD

The present invention relates to the technology field of wastewater treatment, in particular to a method for highly efficient in-situ enrichment of anaerobic ammonium oxidizing bacteria.

### RELATED ART

Anaerobic ammonium oxidation (anammox) technology refers to the biological process in which anaerobic ammonium oxidizing bacteria (AnAOB) convert ammonium as an electron donor and nitrite as an electron acceptor into N₂ in an anaerobic environment (dissolved oxygen less than 0.2 mg/L). Compared to the conventional nitrification-denitrification biological nitrogen removal processes, anammox technology does not require the addition of organic carbon sources and reduces 90% of CO₂ emissions, saving 60% of aeration energy, and 50% of land area. Anammox technology has been maturely applied in high ammonium wastewater treatment such as sludge digestion solution from the sidestream of wastewater treatment plants (WWTPs). However, the total amount of this type of wastewater is small, accounting for only about 1-2% of the total wastewater volume of the WWTPs. Adopting anammox technology to achieve nitrogen removal of mainstream wastewater has huge potential for energy-saving and consumption reduction in large volume and high nitrogen load of mainstream wastewater.

However, the AnAOB has a slow growth rate (0.063/d~0.069/d) and is sensitive to environmental conditions. The conventional methods (providing ammonium and nitrite) mostly use activated sludge from WWTPs as inoculum sludge, which usually takes at least 2-3 months to successfully enrich AnAOB. In addition, compared to sidestream wastewater, mainstream wastewater from WWTPs has the characteristics of low temperature and low ammonium (usually below 50 mg/L). In-situ enrichment of AnAOB in mainstream wastewater takes longer, and even cannot be successfully enriched.

Patent CN110615525A discloses a method and application for enriching AnAOB, which by controlling the concentration of ammonium and/or nitrite in simulated wastewater and different hydraulic mixing conditions, the enrichment culture of AnAOB is optimized in different stages, is significantly improving the AnAOB enrichment culture and anammox start-up process. The start-up process usually could be completed in about 3-4 months.

The conventional method of anammox start-up process using ammonium and nitrite as influent substrates, activated sludge, or mixed sludge containing mature anammox sludge, has better start-up effects than anaerobic digestion sludge. This may be because the activity of AnAOB in anaerobic digested sludge is usually lower than that of activated sludge, and anaerobic digestion sludge is mainly composed of reducing pollutants, which have a certain inhibitory effect on AnAOB. Meanwhile, nitrogen removal-related microorganisms lack sufficient oxidative electron acceptors to react. In the biochemical reaction stage of WWTPs, increasing aeration is a commonly used method, and a series of processes are developed and applied based on the principle of anaerobic-anoxic-aerobic. However, oxygen has an inhibitory effect on AnAOB, so it is difficult to achieve stable and sustainable enrichment of AnAOB in the biochemical treatment stage of WWTPs.

Therefore, there is an urgent need to seek a suitable in-situ enrichment method for AnAOB in WWTPs and promote the widespread application of anammox technology in mainstream wastewater.

### SUMMARY OF INVENTION

The purpose of the present invention is to provide a method for highly efficient in-situ enrichment of AnAOB, to overcome the limitations of existing technology. The method aims to use anaerobic digestion sludge as inoculum sludge, and mainstream nitrate wastewater from WWTPs as influent, thereby achieving in-situ rapid enrichment of AnAOB.

The purpose of the present invention can be achieved through the following technical solutions:

The technical solution of the present invention provides a method for highly efficient in-situ rapid enrichment of AnAOB, comprising:

Using anaerobic digestion sludge as inoculum sludge and nitrate wastewater as influent, the inoculum sludge reacts with the nitrate under conditions of light avoidance, constant temperature, and anaerobic environment to enrich AnAOB.

In some specific implementation methods, the anaerobic digestion sludge is selected from sludge containing any one or more of ammonium, carbon sources, or sulfides.

In some specific implementation methods, the concentration of ammonium in the anaerobic digestion sludge≥0.5 g/kg, the concentration of carbon source≥20 g/L, and the concentration of sulfides≥4 g/kg.

In some specific implementation methods, anaerobic sludge is pretreated before the reaction, and the specific pre-treatment process is to remove the partially oxidized and discolored sludge on the surface of the anaerobic sludge.

In some specific implementation methods, the influent is pretreated before the reaction. The specific pre-treatment process is to remove oxygen from the influent by N₂ aeration so that the dissolved oxygen concentration in the influent is less than 0.2 mg/L.

In some specific embodiments, the nitrate wastewater is selected from any one or more nitrate wastewater containing NO₃⁻—N, NO₂⁻—N, NH₄⁺—N.

In some specific implementation methods, the concentration of NO₃⁻—N in nitrate wastewater is 60-70 mg/L, the concentration of NO₂⁻—N is 0.5-1.0 mg/L, and the concentration of NH₄⁺—N is 5-8 mg/L.

In some specific implementation methods, the volume ratio of inoculated sludge to the influent substrate is 1:9~1:1.

In some specific implementation methods, the constant temperature is 33-37° C.

In some specific implementation methods, the reaction time is 30 cycles, each cycle is 24 hours, with 0.5 hours of influent, 22 hours of stirring reaction, 1 hour of standing, and 0.5 hours of effluent.

The mechanism of in-situ enrichment of AnAOB in the present invention is as follows: heterotrophic bacteria are more competitive in electron acceptors than autotrophic bacteria, when the influent nitrate concentration is appropriate, it will first promote the activity of heterotrophic denitrifying bacteria. Following the carbon to nitrogen (C/N) ratio gradually decreases, insufficient endogenous carbon will induce partial denitrification to produce nitrite; Subsequently, the sulfur autotrophic denitrification activity gradually increases, and as the sulfide to nitrogen (S/N) ratio gradually decreases, insufficient endogenous sulfur will also induce partial denitrification to generate nitrite. Specifically, the entire enrichment process can be roughly divided into two stages. In the first stage, under suitable C/N and S/N, high concentrations of organic matter and sulfides are rapidly reduced, which creates favorable habitats for the occurrence of anammox process. In the second stage, the C/N and S/N gradually decrease, and AnAOB can utilize the nitrite produced by partial denitrification with endogenous ammonium, thus the activity of AnAOB is improved.

The conventional start-up strategy using ammonium and nitrite as influent substrates has three drawbacks. First, the start-up process only be carried out by gradually increasing the nitrogen load from low substrates, because high initial influent substrates like nitrite can inhibit AnAOB. Second, the low concentration of influent substrate in the initial start-up stage cannot effectively improve the inhibitory effect of high carbon and high sulfide environment on AnAOB in the inoculated sludge. Third, lower influent substrate concentration leads to a competitive relationship between denitrifying bacteria and AnAOB, which manifested as a competition for nitrite, thus AnAOB could not obtain sufficient substrate during the initial start-up stage.

Conversely, the start-up strategy of this invention using nitrate as the influent substrate has the following advantages. First, the concentration level of nitrate in the influent usually does not have an inhibitory effect on AnAOB. Second, nitrate has stronger oxidizing properties than nitrite, therefore a higher influent nitrate concentration (higher than the sum of conventional start-up strategies for ammonium and nitrite) can effectively improve the inhibitory effect of high carbon and high sulfide environment on AnAOB, creating a favorable niche for the occurrence of anammox process. Third, the standard electrode potential (E⁰) for NO₃⁻ reduced to N₂ is about +1.24V, while the E⁰ value for NO₂⁻ reduced to N₂ is about 0.96V, indicating that denitrifying bacteria will preferentially utilize nitrate in an environment containing nitrate and nitrite. When the ratio of endogenous electron donors to electron acceptors is low will occur partial denitrification to produce nitrite, which can form a synergistic relationship between denitrifying bacteria and AnAOB.

The uniqueness of the mechanism for in-situ enrichment of AnAOB provided by the present invention lies in using anaerobic digestion sludge as inoculum sludge, utilizing the high concentrations of endogenous sulfide and carbon sources as electron donors, no need for additional carbon and sulfur sources, using nitrate wastewater as influent, determining the optimal volume ratio of influent to inoculum sludge to activate AnAOB to the maximum and achieving in-situ enrichment of AnAOB.

Compared with prior art, the present invention has the following beneficial effects:

The present invention uses anaerobic digestion sludge as inoculum sludge and nitrate wastewater as influent to enrich AnAOB. After about 30 days of operation, the number of anaerobic ammonium oxidizing bacteria increased by approximately three times compared with the original inoculated sludge. On the one hand, there is no need to add additional ammonium and nitrite. On the other hand, there is no need for complex parameter regulation. Through an economical and simple operation method, it can achieve rapid, high efficiency, and sustainable in-situ enrichment of AnAOB in WWTPs.

### DESCRIPTION OF EMBODIMENTS

A detailed explanation of the present invention will be provided with the specific embodiments. This embodiment is based on the technical solution of the present invention and provides detailed implementation methods and specific operation processes. However, the scope of protection of the present invention is not limited to the following embodiments.

In the following embodiments and comparative examples, if there are no specially specified raw materials or processing technologies, it indicates that they are all conventional commercially available raw material products or conventional processing technologies in this field. Anaerobic digestion sludge: taken from a WWTP, containing an ammonium

concentration: 929.3 mg/L, carbon source concentration: 23614.5 mg TCOD/L, and acid volatile sulfur concentration: 7880.2 mg/kg.

Nitrate wastewater: taken from the effluent of anammox reactor, containing NO₃⁻-N concentration: 65 mg/L, NO₂⁻—N concentration: 0.7 mg/L, and NH₄⁺—N concentration of 5.3 mg/L.

### Example 1

A method for highly efficient in-situ enrichment of AnAOB, comprising the following steps:
(1) Remove the surface oxidation discoloration part from the collected anaerobic digestion sludge.
(2) Using an anaerobic serum bottle with a volume of 100 mL, inoculate 10 mL of anaerobic digestion sludge treated in step (1) above.
(3) Remove oxygen from nitrate wastewater by N₂ aeration, reducing the dissolved oxygen concentration to below 0.2 mg/L.
(4) Add 90 mL of nitrate wastewater daily to the anaerobic serum bottle loaded with anaerobic digestion sludge in step (2) for reaction. The anaerobic serum bottle is placed on a constant temperature table concentrator for cultivation, with a temperature set at 35° C. and a speed of 180 rpm. The operating cycle is 24 hours (including 0.5 hours of influent, 22 hours of stirring reaction, 1 hour of standing, and 0.5 hours of effluent), and operates in a dark environment. The operation of changing substrate is to use a needle to suck out the original nitrate wastewater from the anaerobic serum bottle, and then inject the N₂ aeration nitrate wastewater into the anaerobic serum bottle. The substrate change process is carried out in the anaerobic operation box.

The first stage of the enrichment process in this embodiment occurs from 1 to 5 days, characterized by the removal of NO₃⁻—N but no significant accumulation of NO₂⁻—N. The second stage occurs from 6 to 30 days, during which the removal of NO₃⁻—N and the accumulation of NO₂⁻—N are significantly observed to increase synchronously from 6 to 8 days. The removal of NO₃⁻—N is stable and there is continuous accumulation of NO₂⁻—N from 9 to 30 days. On day 7, there was a significant accumulation of NO₂⁻—N(about 1.4 mg/L) in the anaerobic serum bottle, then the average accumulated concentration of NO₂⁻—N was about 2.2 mg/L. On day 16, the stable removal of NH₄⁺—N begins. On day 29, the NH₄⁺—N removal efficiency reached its maximum value of 52.1%, and the removal efficiency of total organic carbon (TOC) and acid volatile sulfur (AVS) in the inoculated sludge were 91.8% and 93.3%, respectively. High-Throughput quantitative PCR results showed that the absolute abundance of AnAOB functional genes HzsB increased by about 100 times compared to the control group 1 (6.90E+04 copies/ng DNA→6.73E+06 copies/ng DNA).

### Control Group 1:

All other conditions are the same as in Example 1, except that the influent substrate is replaced by a mixture of ammonium and nitrite, with concentrations of 14 mg/L and 18.5 mg/L, respectively. However, there is no NH₄⁺—N removal phenomenon observed during the whole 30-cycle operation, and the NO₂⁻—N removal efficiency is less than 50%. Meanwhile, there is no significant removal of TOC and AVS observed in the inoculated sludge. High-throughput quantitative PCR results showed that the number of HzsB functional genes was the same as that in the original inoculated sludge.

The above description of embodiments is for the convenience of ordinary technical personnel in the art to understand and use the invention. Those familiar with the technology in this field can easily make various modifications to these embodiments and apply the general principles explained here to other embodiments without the need for creative labor. Therefore, the present invention is not limited to the aforementioned embodiments, and any improvements and modifications made by those skilled in the art based on the disclosure of the present invention that does not fall outside the scope of the present invention should be within the scope of protection of the present invention.

1. A method for highly efficient in-situ enrichment of anaerobic ammonium oxidizing bacteria (AnAOB), wherein:
using anaerobic digestion sludge as inoculum sludge and nitrate wastewater as influent, the inoculum sludge reacts with the nitrate wastewater under conditions of light avoidance, constant temperature, and anaerobic environment to enrich AnAOB.

2. A method for highly efficient in-situ enrichment of AnAOB according to claim 1, wherein the anaerobic digestion sludge is selected from sludge containing any one or more of ammonium, carbon sources, and sulfides.

3. A method for highly efficient in-situ enrichment of AnAOB according to claim 1, wherein concentration of the ammonium in the anaerobic digestion sludge≥0.5 g/kg, concentration of the carbon source (total chemical oxygen demand)≥20 g/L, and concentration of the sulfides≥4 g/kg.

4. A method for highly efficient in-situ enrichment of AnAOB according to claim 1, wherein the anaerobic digestion sludge is pretreated before the reaction, and the specific pre-treatment process is to remove partially oxidized and discolored sludge on surface of the anaerobic digestion sludge.

5. A method for highly efficient in-situ enrichment of AnAOB according to claim 1, wherein the influent is pretreated before the reaction, and specific process of the pretreatment is: N₂ aeration removes oxygen from the influent so that dissolved oxygen concentration in the influent is less than 0.2 mg/L.

6. A method for highly efficient in-situ enrichment of AnAOB according to claim 1, wherein the nitrate wastewater is selected from nitrate wastewater containing any one or more of NO₃⁻—N, NO₂⁻—N, NH₄⁺—N.

7. A method for highly efficient in-situ enrichment of AnAOB according to claim 6, wherein concentration of the NO₃⁻—N in the nitrate wastewater is 60-70 mg/L, concentration of the NO₂⁻—N in the nitrate wastewater is 0.5-1.0 mg/L, and concentration of the NH₄⁺—N in the nitrate wastewater is 5-8 mg/L.

8. A method for highly efficient in-situ enrichment of AnAOB according to claim 1, wherein volume ratio of the inoculated sludge to the influent substrate is 1:9~1:1.

9. A method for highly efficient in-situ enrichment of AnAOB according to claim 1, wherein the constant temperature is 33-37° C.

10. A method for highly efficient in-situ enrichment of AnAOB according to claim 1, wherein reaction time is 30 cycles, each cycle is 24 hours, with 0.5 hours of influent, 22 hours of stirring reaction, 1 hour of standing, and 0.5 hours of effluent.
